(19) United States
(12) Patent Application Publication
(10) Pub. No.: US 2012/0257054 A1
(43) Pub. Date: Oct. 11, 2012

(54) VISUAL MONITORING DEVICE

(75) Inventor: Denis Maurin, Le Barp (FR)

(73) Assignee: PRODITEC, Pessac (FR)

(21) Appl. No.: 13/516,833

(22) PCT Filed: Dec. 16, 2010
(86) PCT No.: PCT/FR2010/052766

§ 371 Date: Jun. 18, 2012

(30) Foreign Application Priority Data
Dec. 16, 2009 (FR) 09 59068

(51) Int. Cl. H04N 7/18

(52) U.S. Cl. 348/143; 348/E07.085

(57) ABSTRACT

A device (10) for visually monitoring products (P), includes at least one conveyor (14) having at least one belt (16) carrying the products (P) in one direction (S) towards a visual monitoring unit (18), and an element for launching (30) products (P) through the visual monitoring unit located at the end (22) of the conveyor in the direction thereof (S), the visual monitoring unit including an image-capturing device and an optical device, wherein the capturing device is a single camera, having a sensor line and axis, pointing towards the path of the products through the optical device, which includes at least one mirror located behind the path of the launched products relative to the exposure station of the camera. A double periscope is inserted between the camera and the path of the products, and at least two sets of mirrors are installed symmetrically on either side of the axis.

This invention relates to visual monitoring of products moving past in front of visual monitoring means such as a camera.

More particularly, the invention is aimed at implementation of automated visual monitoring of products moving past at operating rates of from 0.3 to 1 meter per second or more.

During the development of a visual monitoring device, the different functional requirements that are pursued can lead to paradoxical characteristics.

For example, the increase of the operating rate generally reduces the repeatability and precision of the monitoring that is carried out, whereas the adaptability of the device to many types of products entails an increase in the number or capacities of the components and thus in the overall cost of said device.

Thus, a first visual monitoring device is known that is described in French Patent Application No. 07 54027 in the name of the same applicant.

This first automated visual monitoring device makes it possible to inspect products moving past essentially continuously in one given direction.

For this purpose, the automatic monitoring device comprises a conveyor followed by guide means that keep the products under the visual monitoring means such as a camera during their passage.

More exactly, the products are kept in an exact position by said guide means during the visual monitoring, i.e., they all pass in the same position in the camera field, the precision and repeatability of the monitoring depending on the identity of the positions of passage of said products.

For inspection of the hidden surface(s) of the products, the guide means comprise at least one slot that is aligned with at least one reflection surface located in the camera field behind the passage site of the products.

While only a single camera is necessary for the inspection of almost all of the surfaces of the products, this first monitoring device cannot be adapted to all products.

Actually, taking, for example, the case of pharmaceutical products, round tablets always arrive in the same position at the level of the guide means, given their shape of revolution.

However, in the case of tablets with a convex surface, and especially when products move past at the operating rates intended by this invention, there is a risk of instability during transfer between the conveyor and the guide means if one of the capsules arrives mispositioned.

This first visual monitoring device thus is not suited to inspection of products with convex surfaces.

A second type of visual monitoring device is also known that integrates an overturning device and that is suitable for inspection of all of the surfaces of many types of products.

In the transfer line, said overturning device is located downstream from the first visual monitoring means and upstream from the second visual monitoring means, the overturning of the products allowing the second monitoring means to inspect the hidden surface(s) of the products during their passage under the first visual monitoring means.

Such an overturning device is described in French Patent Application No. 0754033 in the name of the same applicant and comprises at least one overturning wheel that is mounted to rotate around an axis as well as two belts enclosing the products during the overturning, an entry belt conveying the products and guided by two internal bearing surfaces of said wheel, and an exit belt discharging the overturned products and guided by two external bearing surfaces of said wheel.

The positioning of the products at regular intervals according to the axis of transport is obtained using suitable means on the entry belt; this positioning and these regular intervals are maintained by the enclosing of the products between the belts during the overturning, regardless of the shape, of revolution or not, of said products.

Although allowing adaptation of visual monitoring to many product types while ensuring the repeatability and quality of said monitoring, this overturning device increases the bulkiness of said visual monitoring device and requires the use of at least two cameras, at least one first camera for the first visual monitoring means and at least one second camera for the second visual monitoring means.

Since a production line of pharmaceutical products or others can comprise several transfer lines of products to be inspected before their discharge, the bulkiness and cost of visual monitoring by overturning the products can increase very quickly, especially due to the cost of the cameras.

Moreover, although adaptable, an overturning device must nevertheless be adjusted for each type of product if optimum operation of the transfer line is desired, i.e., for the best compromise between operating rate/quality of visual monitoring.

Finally, according to one major drawback, the use of an overturning device does not make it possible to ensure identical positioning of all of the products during two recordings registered by the first and second visual monitoring means, the products being susceptible to movement during transport between said visual monitoring means and the overturning device.

This invention is also designed to ameliorate the drawbacks of the prior art by suggesting a visual monitoring device allowing accurate and reliable inspection with a single camera of all of the surfaces simultaneously of the products moving past in the field of said camera.

Moreover, the device according to the invention can be easily adapted to visual monitoring of all types of products, especially to tablets with convex surfaces.

To do this, the object of the invention is a device for visual monitoring of products, comprising at least one conveyor transporting the products toward the visual monitoring means, and means of launching products through said visual monitoring means, said visual monitoring means comprising an image acquisition device and an optical device, said visual monitoring device being characterized in that the acquisition device is a single camera oriented toward the trajectory of the products through the optical device, and in that the optical device comprises at least one mirror that is located behind the trajectory of the products, a double periscope that is inserted between the camera and the trajectory of the products, and at least two sets of mirrors that are mounted symmetrically on either side of the axis of said camera.

Other characteristics and advantages will become apparent from the following description of the invention, a description given solely by way of example, with respect to the accompanying drawings in which:

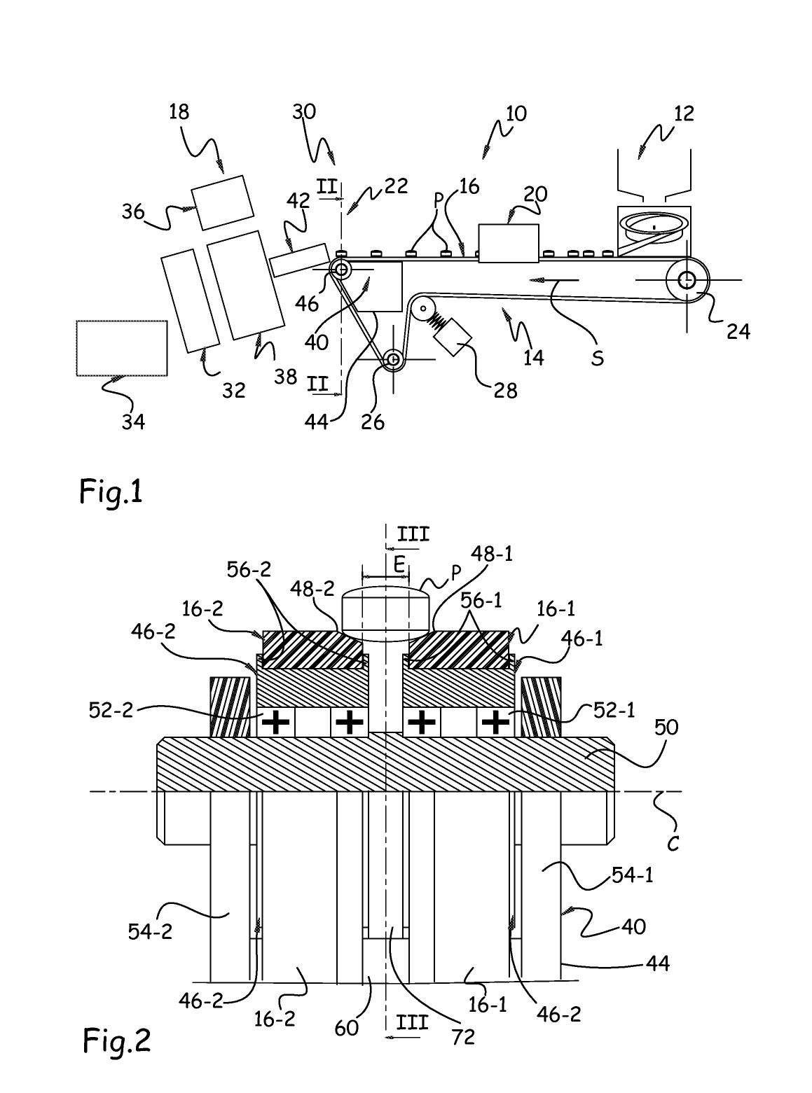

FIG. 1 schematically shows a visual monitoring device according to the invention,

FIG. 2 shows a transversal half-section of one end of a conveyor of the visual monitoring device according to the invention,

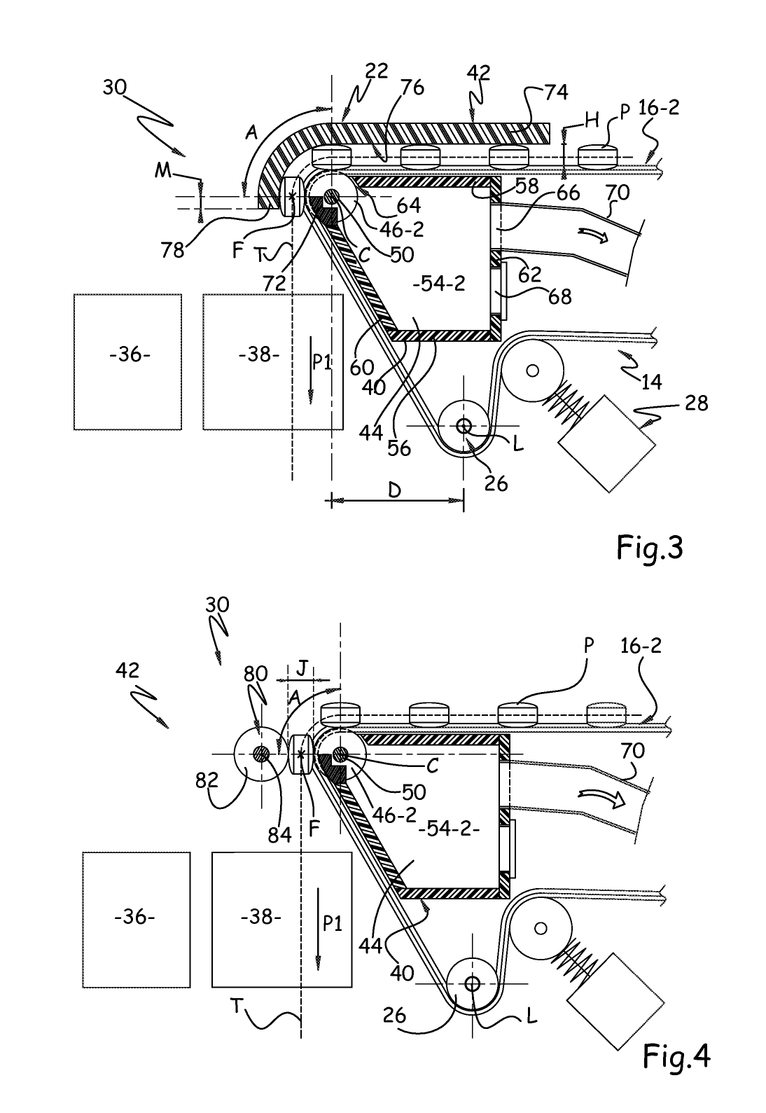

FIG. 3 shows a longitudinal cutaway view of a first variant of the launching means of the visual monitoring device according to the invention,

FIG. 4 shows a longitudinal cutaway view of a second variant of the launching means of the visual monitoring device according to the invention,

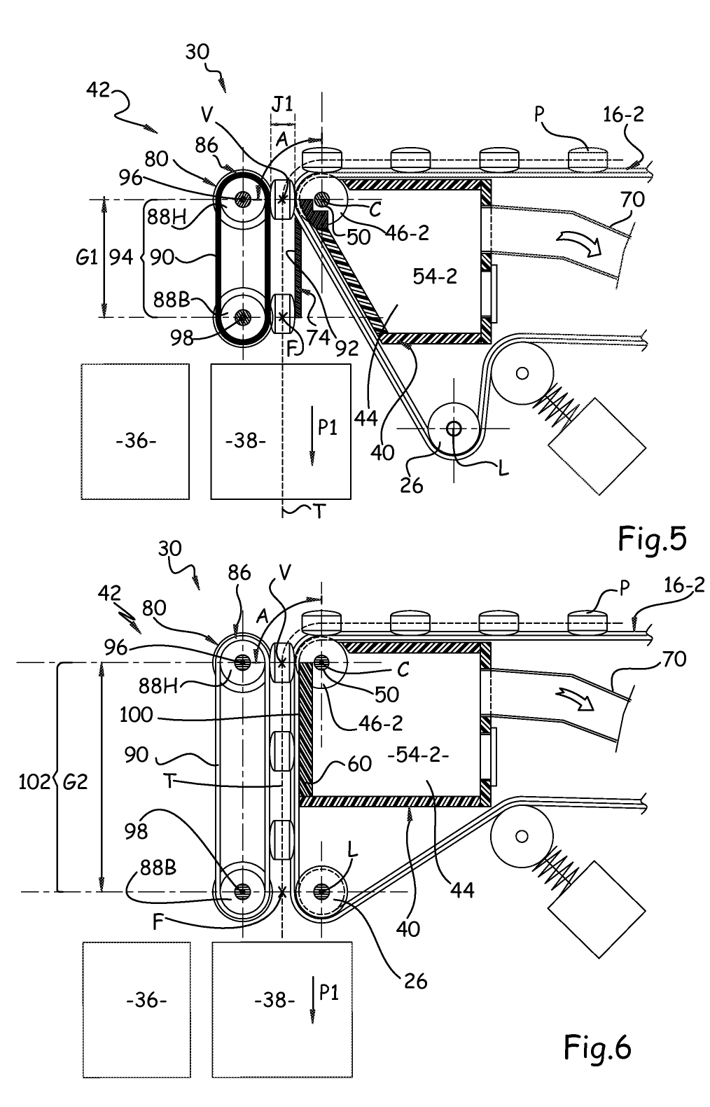

FIG. 5 shows a longitudinal cutaway view of a third variant of the launching means of the visual monitoring device according to the invention,

FIG. 6 shows a longitudinal cutaway view of a fourth variant of the launching means of the visual monitoring device according to the invention,

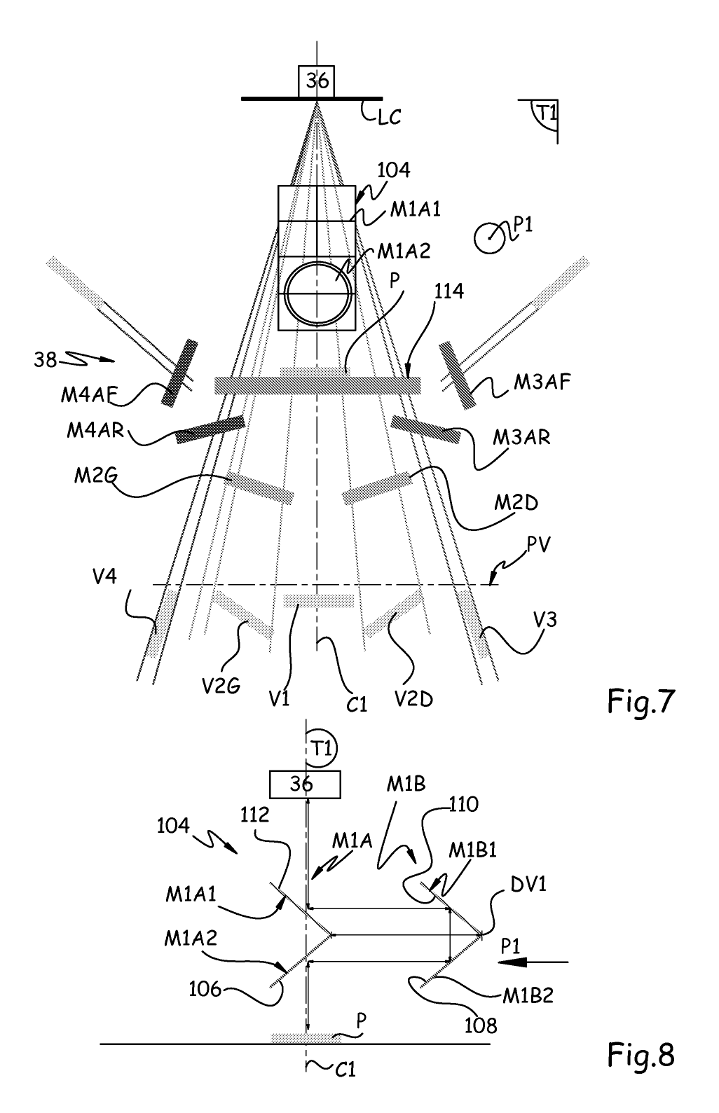

FIG. 7 shows a first embodiment of an optical device of the visual monitoring device according to the invention,

FIG. 8 shows a double periscope of an optical device of the visual monitoring device according to the invention,

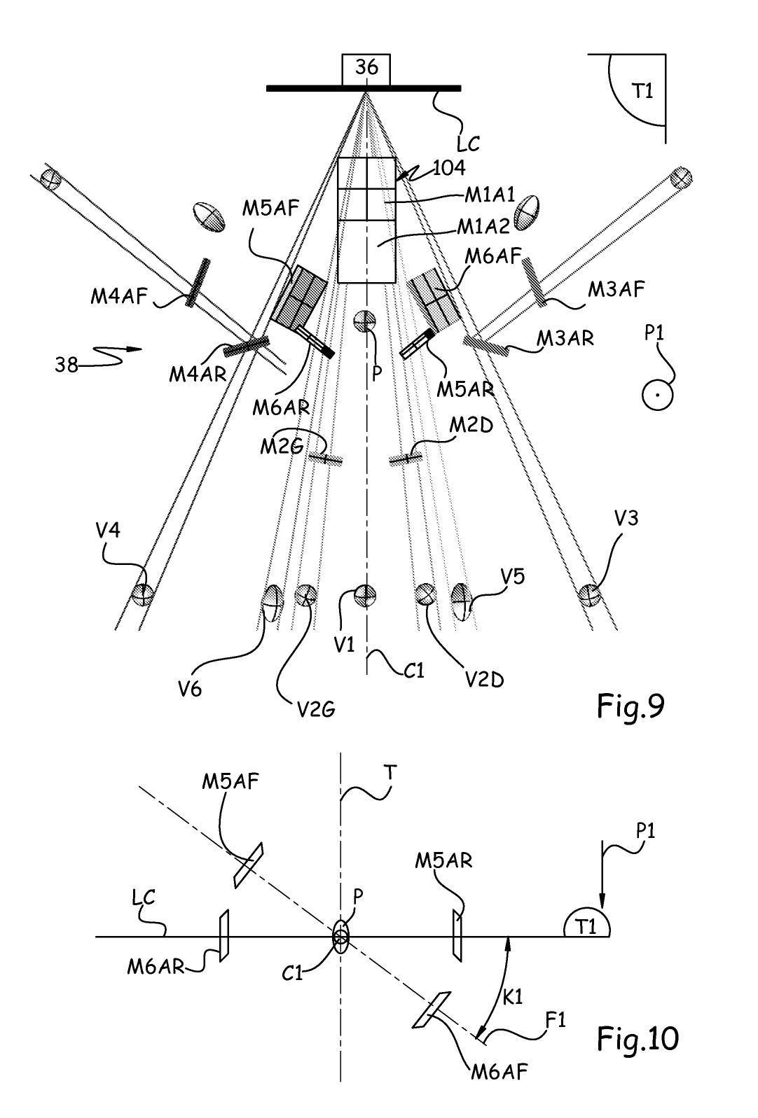

FIG. 9 shows a second embodiment of the optical device of the visual monitoring device according to the invention,

FIG. 10 shows a top view of the sets of complementary mirrors of a second embodiment of an optical device of the visual monitoring device according to the invention.

FIG. 1 illustrates a visual monitoring device 10 according to the invention, such that it can be integrated into a transfer line of products P to be monitored.

Products P are defined in the invention as products such as pharmaceutical tablets or capsules, coins, caps, . . . .

To provide a rough idea, the invention is more particularly aimed at the monitoring of products P whose dimensions are of several centimeters.

Thus, a transfer line generally comprises feed means 12 distributing the products P to be monitored upstream from the visual monitoring device 10.

For example, these feed means 12 can consist of a hopper discharging the products loose into a bowl using centrifuging, for promptly aligning the products behind one another, and the hopper is equipped with guides for the sorting and the orientation of the products.

Then, said products P are distributed by said feed means 12 onto at least one conveyor 14 of the device 10 according to the invention.

Said conveyor 14 comprises at least one belt 16 on which the products P to be monitored are transported in one direction S toward the visual monitoring means 18 of the device 10.

Advantageously, positioning means 20 can be provided at the level of the conveyor 14 between the feed means 12 and the visual monitoring means for orienting all of the products P into the same position and for spacing them in a uniform manner.

Preferably, the belt conveyor 14 comprises at least one drive pulley 24, at least one free pulley 26, and at least one tensioning roll 28.

At the end 22 of the conveyor 14 following the transport direction S of the products, the visual monitoring device 10 comprises means 30 for launching the products P through visual monitoring means 18, said means 18 being followed by a sorting device 32 that makes it possible to remove, especially eject by blowing, defective monitored products P, and means 34 for receiving, especially a tray, of products P that are not defective.

More exactly, the visual monitoring means 18 comprise an image acquisition device 36, preferably a single linear camera, and an optical device 38 allowing simultaneous acquisition of the images of different surfaces of a product P when it passes through the field of the camera 36.

Since the products P reach a nonzero speed V at the level of the end 22 of the conveyor 14, the launching means 30 comprise at least suction means 40 that make it possible to hold and orient the products P for release when they leave the conveyor 14 and to influence their trajectory when they pass through the optical device 38.

Preferably, said means 30 for launching each product P from the conveyor 14 to a release point F comprise guide means 42 combined with suction means 40, enhancing the monitoring of the trajectory of the products P at high rates up to one meter per second, to provide a rough idea.

The visual monitoring device 10 according to the invention is now described according to one particular but nonlimiting embodiment.

Thus, in one preferred embodiment of said device 10, the suction means 40 take the form of a suction box 44 that is integrated into the conveyor 14 at the level of its end 22, said suction box 44 comprising at least one guide pulley 46 of the at least one belt 16 of the conveyor 14.

In order to stabilize the products, the belt 16 can be grooved and perforated, the products P coming to rest in the longitudinal groove of the belt and being kept there by suction through the perforations.

However, in order to adapt to a larger number of products, especially to different types of tablets, and as illustrated in FIG. 2, the conveyor 14 preferably comprises two parallel belts 16-1, 16-2, separated by an air gap E and of which the upper edge 48-1, 48-2 adjacent to said air gap E is beveled to stabilize the products P during their transfer onto the conveyor 14.

Said belts 16-1, 16-2 are advantageously locked in place and driven synchronously by toothed and motorized pulleys 24-1, 24-2 in such a way as to transfer the products P at the desired speed V.

Moreover, at the level of the end 20 of the conveyor 14, each belt 16-1, 16-2 is guided by one pulley 46-1, 46-2 respectively, supported by the suction box 44.

In greater detail, said pulleys 46-1, 46-2 are mounted to rotate freely on a shaft 50 via pillow blocks 52-1, 52-2, and the suction box 44 comprises two lateral surfaces 54-1, 54-2 keeping said shaft 50 outside of the pulleys 46-1, 46-2 on either side.

In order to limit the oscillations of the belts 16-1, 16-2 at the level of the end 20 of the conveyor 14 and due to the high tension to which they are subjected, said pulleys 46-1, 46-2 are smooth.

And, in order to prevent any lateral movement of the belts at the level of the end 20 of the conveyor 14, said pulleys 46-1, 46-2 are equipped with end shields 56-1, 56-2 laterally enclosing each of said belts.

Thus, the smooth and slack pulleys 46-1, 46-2 create optimum conditions for the release and launching of each product.

Advantageously, to better adapt the visual monitoring device 10 to all types of products P, the air gap E between the belts 16-1, 16-2 can be adjustable, a suitable adjustment device that is not shown but that can be designed with the knowledge of one skilled in the art, allowing at least the drive pulleys 24, 24-1, 24-2 and the free pulleys 46, 46-1, 46-2 to be identically and simultaneously moved together/apart.

FIG. 3 shows in detail the suction box 40 of the suction means 44.

In addition to the two lateral surfaces 54-1, 54-2, said suction box 40 comprises a bottom 56, a cover 58, a front surface 60, and a rear surface 62 that are integral with one another.

The cover 58 and the front surface 60 expose a housing 64 at the level of the end 22 of the conveyor 14 for the insertion of the pulleys 46-1, 46-2 mounted on the shaft 50, whereas the rear surface 62 comprises at least two openings, one top opening 66 and one bottom opening 68 for the branching of an air suction line 70.

Thus, when the product P arrives at the level of the end 22 of the conveyor 14, i.e., at the level of the pulleys 46-1, 46-2, it is kept pushed against the belts 16-1, 16-2 by the air sucked through the air gap E separating said belts, or possibly through perforations that have been made in a belt 16.

According to the invention, the suction means 40 and the guide means 42 accompany each product from the conveyor 14 to the release point F. In fact, said suction means 40 and said guide means 42 accompany each product P from one conveyance position, essentially horizontal, to a launching position corresponding essentially to the position in which said products pass through the field of the acquisition device 36 and are monitored.

Different trajectories of the products P can also be envisioned for implementing visual monitoring, ranging from an essentially horizontal trajectory to an essentially vertical trajectory.

To improve the precision and quality of the visual monitoring, it is necessary that said products P follow an essentially rectilinear trajectory T on a minimum portion located in the field of the camera 36.

To provide a rough idea, said products must follow an essentially rectilinear trajectory over a greater distance than the largest of the dimensions of the products passing through the field of the camera 36.

For better adaptability of the visual monitoring device 10 to certain types of pharmaceutical tablets, the invention prefers a launching of said products following an essentially vertical and downward direction P1.

Consequently, in the different variant embodiments of the launching means 30 shown in FIGS. 3 to 6, the products P are accompanied in rotation by the guide means 42 and the suction means 40 on at least one angular sector A essentially equal to one quarter turn and extending from the essentially horizontal conveyance position to the release point F, corresponding to an essentially vertical position, the trajectory T followed by the products P being shown by broken lines in FIGS. 3 to 6.

During this rotation of a quarter turn, each product P is kept pushed against the belts 16, 16-1, 16-2 of the conveyor by the suction means 40, said suction being able to be varied on said angular sector A in order to be adapted to each type of product P.

Thus, when the suction line 70 is connected to the bottom opening 68, the product P is more strongly suctioned at the start of the angular sector A, and the suction gradually decreases as far as the end of said sector A, and when the suction line 70 is connected to the top opening 66, the product P is more weakly suctioned at the start of the angular sector A, and the suction gradually increases as far as the end of said sector A.

In order to prevent the suction from disrupting the trajectory of the product P when it has reached the vertical position, ready to be released, the suction means 40 comprise a suction seal 72 extending the front surface 60 of the suction box 44 between the pulleys 46-1, 46-2.

More exactly, as illustrated in the transverse half-section of FIG. 2, the suction seal 72 extends as far as the height of the central axis C of the shaft 50 on which the pulleys 46-1, 46-2 are mounted, the level of said axis C corresponding to the arrival of the product P in the vertical position in the trajectory T that has been imparted by the combination of suction means 40 and guide means 42.

FIGS. 3 to 6 illustrate different nonlimiting variants of the launching means 30 and more particularly of the combination of guide means 42 with the suction means 40.

Thus, according to a first variant embodiment that is illustrated in FIG. 3, the guide means 42 take the form of a fixed guide 74 that is located above the end 22 of the conveyor 14, the lower wall 76 of said guide 74 emerging to a height H of the belts 16-1, 16-2 and routing the products P onto a portion extending at least from the conveyor 14 to the release point F, corresponding to the arrival of the products in a vertical position, which point is located at the height of the central axis C of the shaft 50.

Thus, the guide 74 makes it possible to prevent the detachment of the products P until they arrive in a vertical position, regardless of the adjustment of the suction.

Advantageously, the fixed guide 74 is mounted to be adjustable in height to adapt to various products P, said height H being adjusted to guide the products without slowing them down.

Still to prevent slowing down the products P, the guide 74 is preferably made of PTFE (polytetrafluoroethylene) or any other material with an adequately low friction coefficient.

Moreover, a vertical extension 78 of the guide 74 can be provided over a short maintenance distance M below the release point F in order to continue to hold the product P on a vertical path just before releasing it, this maintenance distance M making it possible to make the straightness of the trajectory of the products P that have been launched more reliable.

In this first variant, the suction box 44 comprises only one pair of pulleys 46-1, 46-2; the point of arrival of the products P in the vertical position is the release point F of said products and is located at the height of the central axis C of the shaft 50 on which the pulleys 46-1, 46-2 are mounted.

Moreover, the front surface 60 of the suction box 44 is tilted in such a way as to move gradually away from the essentially vertical trajectory T of the products P below the release point F, and the axis L of the first pulley 26 of the conveyor after the pulleys 46-1, 46-2 is set back by a nonzero distance D relative to the axis C in such a way as to move the belts 16-1, 16-2 gradually farther away from the trajectory T of the products P below the release point F.

Finally, in this first variant, the optical device 38 and the camera 36 are located below and to the right of the release point F of the products P at a distance of roughly 5 centimeters, to provide a rough idea.

According to a second variant embodiment that is illustrated in FIG. 4, the suction means 40, including especially the suction box 44, are identical to those of the first variant, but the guide means 42 are composed of a mobile guide 80 allowing the driving speeds to be balanced on either side of the product P for the launching.

In this second variant, said mobile guide 80 assumes the form of a pulley 82 that is mounted opposite the pulleys 46-1, 46-2, the axis 84 of said pulley 82 being located essentially at the same height as the axis C of the shaft 50 supporting the pulleys 46-1, 46-2.

Said pulley 82 is mounted at a suitable distance J for enclosing the products P without damaging them at the instant they arrive in the vertical position, the arrival point of the products in the vertical position also corresponding to the release point F of the products.

Advantageously, the distance J can be adjusted to adapt the device to different products P.

Moreover, said pulley 82 is motorized and driven essentially at the same speed as the belts 16-1, 16-2 of the conveyor 14, this allowing equalization of the speeds that have been imparted to the product P by said pulley 82 and by said belts 16-1, 16-2.

In this second variant, only the suction means 40 make it possible to prevent detachment of the products P until they arrive in the vertical position, i.e., at the release point F.

The pulley 82 is preferably made of stainless steel.

Finally, in this second variant, and just like in the preceding variant, the optical device 38 and the camera 36 are located below and to the right of the release point F of the products P.

According to a third variant embodiment that is illustrated in FIG. 5, the suction means 40, including especially the suction box 44, are identical to those of the first and the second variants, but the guide means 42 are composed of a mobile guide 80 combined with a fixed guide 74, this combination making it possible to advantageously improve the balance of the driving speeds on either side of the product P for its launching.

In this third variant, said mobile guide 80 assumes the form of a second conveyor 86 that is mounted essential vertically, and comprising two pulleys, one top pulley 88H and one bottom pulley 88B, guiding at least one driving belt 90, or belt.

And, said fixed guide 74 itself is also mounted essentially vertically and offers an essentially vertical guide surface 92, enclosing the products P with the driving belt 90.

More exactly, the guide surface 92 is essentially tangential to the pulleys 46-1, 46-2 of the suction box 44, and the upper end 93 of said guide 74 makes the pulleys 46-1, 46-2 flush in order to extend the guiding of the products continuously.

The driving belt 90 of the conveyor 86 and the guide surface 92 of the guide 74 enclose the products P on a vertical portion 94 of their trajectory T that is located following their arrival point in the vertical position.

In this third variant, only the suction means 40 make it possible to prevent the detachment of the products P until they reach the vertical position corresponding to the point V illustrated in FIG. 5, and said vertical portion 94 is located between said point V and the release point F of the products, the point V and the point F being separated by a nonzero guide distance Gl.

More exactly, the top pulley 88H is mounted opposite the pulleys 46-1, 46-2, the axis 96 of said pulley 88H being located essentially at the same height as the axis C of the shaft 50 of said pulleys 46-1, 46-2, and the axis 98 of the pulley 88B is located below and at a distance G from the axis 96 of the top pulley 88H.

The top pulley 88H and the bottom pulley 88B are mounted at a distance J1 from the pulleys 46-1, 46-2 as well as from the surface 92 of the guide 74, said distance J1 being suitable, and preferably adjustable, for enclosing the products P without damaging them over the length G1 of the vertical portion 94.

Moreover, at least one of the pulleys 88H, 88B is motorized and driven essentially at the same speed as the belts 16-1, 16-2 of the conveyor 14, in order to equalize the speed imparted to the product P by said vertical conveyor 86 with the speed imparted by said belts 16-1, 16-2 and the sliding on the guide 74.

Finally, in this third variant and as in the preceding variants, the optical device 38 and the camera 36 are located below and to the right of the release point F of the products P.

According to a fourth variant embodiment of the launching means 30, especially perfected and illustrated in FIG. 5, the guide means 42 comprise, as in the preceding variant, a mobile guide 80 taking the form of a second conveyor 86 that is mounted essentially vertically and comprising two pulleys, one top pulley 88H and one bottom pulley 88B, guiding at least one driving belt 90, or belt.

In this fourth variant, the second conveyor 86 of the mobile guide 80 is combined with the belts 16-1, 16-2 of the first conveyor 14 for balancing the speeds that have been imparted to the product P on either side before its launching.

Thus, the driving belt 90 of the conveyor 86 and the belts 16-1, 16-2 of the conveyor 14 enclose the products P on a vertical portion 102 of their trajectory T located following their point of arrival in the vertical position.

In this fourth variant, only the suction means 40 make it possible to prevent the detachment of the products P until they reach the vertical position corresponding to the point V illustrated in FIG. 6, and said vertical portion 102 is located between said point V and the release point F of the products, the point V and the point F being separated from one another by a nonzero guide distance G2.

For this purpose, the front surface 60 of the suction box is essentially vertical, and its external surface 100 is tangential to the pulleys 46-1, 46-2, and the axis L of the free pulley 26 of the conveyor 14 is aligned vertically with the axis C of the shaft 50 and of the pulleys 46-1, 46-2.

Moreover, the axis 96 of the pulley 88H is located at the same height as the axis C of the shaft 50, and the axis 98 of the pulley 88B is located at the same height as the axis L of the pulley 26, said axis 98 of the pulley 88B and said axis L of the pulley 26 being located respectively at a distance G2 from the axis 96 of the pulley 88H and from the axis C of the shaft 50.

The top pulley 88H and the bottom pulley 88B are mounted at a distance J2 from the pulleys 46-1, 46-2 and from the pulley 26, said distance J2 being suitable, and preferably adjustable, for enclosing the products P without damaging them over the length G2 of the vertical portion 102.

Next, at least one of the pulleys 88H, 88B is motorized and driven essentially at the same speed as the belts 16-1, 16-2 of the conveyor 14 in order to equalize the speed imparted to the product P by said vertical conveyor 86 with the speed imparted by said belts 16-1, 16-2.

Finally, in this fourth variant, and as in the preceding variants, the optical device 38 and the camera 36 are located below and to the right of the release point F of the products P.

As specified above and regardless of the variant embodiment of the launching means 30 and the direction P1 of their trajectory T following the release point F, the launched products P pass through an optical device 38 in the field of an acquisition device 36 of images of different views of said products.

According to the invention, the acquisition device 36 is a single linear camera of sensor line LC and of axis C1 oriented toward the trajectory T of the products through the optical device 38.

More exactly, the plane T1, defined by the sensor line LC of the linear camera 36 and by its axis C1, is secant to the direction P1 of the trajectory T of the products in the optical device 38.

Preferably, said camera 36 is located essentially perpendicular to the direction of passage P1 of the products P through the optical device 38, i.e., the axis C1 of said camera 36 is essentially perpendicular to the direction P1 of the launched products.

Also, preferably, the sensor line LC is essentially perpendicular to the direction Pl, and the plane T1 that is defined by said sensor line LC of the linear camera 36 and by its axis C1 is also essentially perpendicular to the direction P1 of the trajectory T of the products P in the optical device 38.

Again preferably, but not necessarily, said axis C1 essentially symmetrically intersects said products P in the plane T1 during their visual inspection. Said optical device 38 is a system of several mirrors bringing the images of the different views of a product P back toward the sensor line of said linear camera 36, i.e., allowing a display of over 360 degrees of a product P for implementing its visual monitoring via one or more subsequent image processing cycles.

According to a first embodiment, the optical device 38 makes it possible for the camera 36 to display at least one top view V1 of a product P that has been launched in the direction P1, one bottom view V2, one first side view V3 of a first side of the product P, and one second side view V4 of a second side of the product P opposite the first.

To obtain the bottom view V2 of the product P, the optical device 38 comprises at least one mirror M2 located behind the trajectory T of the products P launched relative to the viewpoint of the camera 36, said mirror M2 being perpendicular to the plane T1.

However, in order to recover the entire bottom view V2 without exceeding the depth of field of the camera 36 by tilting the mirror M2 too much, the device 38 preferably comprises one set of two mirrors M2D and M2G located behind the trajectory T of the products P relative to the view point of the camera 36 and arranged essentially symmetrically on either side of the axis C1 of the camera, said mirrors M2D and M2G being oriented toward the trajectory T of the products P and both perpendicular to the plane T1.

Said mirrors M2D and M2G thus send two bottom half-views V2G and V2D to the sensor of the camera 36, either in the viewing plane PV of said camera illustrated schematically in FIG. 7, said half-views V2G and V2D being more useful for the visual monitoring than a single view from a single mirror.

To provide a rough idea, the two mirrors M2D and M2G are preferably tilted between ten degrees and twenty degrees relative to the sensor line LC.

Then, since the bottom half-views V2G and V2D fix the longest optical path between the product P and the camera 36, a double periscope 104 is used to lengthen the optical path of the top view V1.

The invention defines the optical path as the distance traversed by the image of one view of a product, i.e. light rays, from said product, by passing by the reflection or reflections on different mirrors, and up to the camera sensor.

Thus, to lengthen the optical path of the top view V1, said double periscope 104 is inserted between the camera 36 and the trajectory T of the product P.

As illustrated in FIG. 8, said double periscope 104 comprises two sets M1A and M1B of two mirrors (M1A1, M1A2) and (M1B1, M1B2) in a V inverted by a quarter turn relative to the axis C1 of the camera, said mirrors (M1A1, M1A2) and (M1B1, M1B2) of each set M1A and M1B being essentially perpendicular to one another as well as relative to the plane T1, and the mirror M1A2 being oriented toward the trajectory T of the products P.

The set M1A of mirrors (M1A1, M1A2) is located on the axis C1 between the camera 36 and the trajectory of the products P, and the second set M1B of mirrors (M1B1, M1B2) is located at a distance DV1 from the first set M1A of mirrors (M1A1, M1A2), the distance DV1 being adapted so that the optical path of the top view V1 is essentially equal to that of the bottom half-views V2G and V2D.

Thus, from the product P to the lens of the camera 36, the image of the top view V1 is reflected consecutively by the exterior surface 106 of the mirror M1A2, then by the interior surface 108 of the mirror M1B2, then by the interior surface 110 of the mirror M1B1, and finally by the exterior surface 112 of the mirror M1A1 toward said camera.

Just as for the top view V1, and also using one mirror, the optical path between the side views V3 and V4 and the sensor of the camera 36 must be lengthened to equal essentially that of the bottom half-views V2D and V2G.

Also, in order to bring said side views V3 and V4 back into the viewing plane of the camera 36, the optical device 38 according to the invention comprises at least two sets M3A and M4A of mirrors, each set (M3A, M4A) comprising, respectively, one fixed mirror (M3AF, M4AF) that is oriented toward the trajectory T of the products and one adjustable mirror (M3AR, M4AR) that is tilted to adjust the clarity of the images of the views V3 and V4 that are sent to the camera and to compensate for the effects of parallax on the edge of the optical field, said mirrors (M3AF, M4AF, M3AR, M4AR) being perpendicular to the plane T1.

Preferably, said sets M3A and M4A are mounted symmetrically on either side of the axis C1, the fixed mirrors (M3AF, M4AF) being oriented at 70 degrees relative to the sensor line LC and toward the trajectory T of the products P, and the adjustable mirrors (M3AR, M4AR) being positioned under said fixed mirrors and being inclined roughly 14 degrees relative to the sensor line LC.

Thus, due to the different sets of mirrors allowing the images of different views of a product P in the same plane of view to be restored, the optical device 38 enables the acquisition of rather clear images, i.e., reliable and accurate visual monitoring by a single camera 36.

Moreover, due to the regrouping of the images of the different views into the viewing plane of the camera 36, a single adjustment of said camera is necessary for the set of views.

But if the acquisition of only two side views is sufficient for certain products, especially cylindrical products such as coins, it is not so for other products such as certain ellipsoidal pharmaceutical tablets or those with at least one convex surface.

However, in a second embodiment shown in FIG. 9, and especially optimized for visual monitoring of products such as medications, the optical device 38 comprises two supplementary sets of mirrors M5A and M6A complementing the two preceding sets of mirrors M3A and M4A in order to acquire two supplementary side views V5 and V6 in addition to the two preceding side views V3 and V4.

Advantageously, said views V5 and V6 are essentially opposite and are located between the views V3 and V4 in order to complement the side view over 360 degrees of a product P that is reconstructed by the image processing means that are connected to the camera 36.

In this second optimized embodiment, and as shown schematically in FIG. 10, the two sets of mirrors M5A and M6A are arranged rotationally symmetrically around the axis C1 of the camera, i.e., on either side of the trajectory T of the products P.

Said supplementary sets M5A and M6A comprise one fixed mirror (M5AF, M6AF) and one adjustable mirror (M5AR, M6AR) respectively, tilted to adjust the clarity of the images of views V5 and V6 sent to the camera and to compensate for the effects of parallax on the edge of the optical field, the fixed mirrors (M5AF, M6AF) being oriented toward the trajectory T of the products P and arranged on one axis F1 perpendicular to the axis C1 of the camera and tilted at an angle K1 relative to the plane T1, and the adjustable mirrors (M5AR, M6AR) being aligned to the sensor line LC of the camera.

Thus, the product P up to the sensor of the camera 36, the image of the side view V5, or V6, is reflected consecutively by the mirror M5AF, or M6AF, and then by the mirror M5AR, or M6AR. Preferably the angle of inclination K1 of the axis F1 relative to the plane T1 is fixed to be equal to 30 degrees.

According to one variant of this second embodiment, the plane T1, perpendicular to which the mirrors (M1A1, M1A2, M1B1, M1B2, M2G, M2D, M3AF, M4AF, M3AR, M4AR) are arranged, can be tilted around the axis C1 and relative to a plane perpendicular to the direction P1, and the angle K1 of the axis F1 can be modified in order to acquire the best images of the side views V3, V4, V5, and V6 of the product P.

Advantageously, there are coverage zones between the views that have been acquired using different mirrors (M1A1, M1A2, M1B1, M1B2, M2G, M2D, M3AF, M4AF, M3AR, M4AR, M5AF, M6AF, M5AR, M6AR) in order to ensure the inspection of the entire outer surface of the products P.

Optionally, as illustrated in FIG. 7, and regardless of the direction P1 of the trajectory T of the products P launched by the launching means 30, the visual monitoring device 10 can provide means 114 for holding the products P when they are passing through the optical device 38 in the field of the camera 36.

These holding means 114 can come in the form of a grooved guide ramp, said groove being matched to the shapes of the product, and slit transversely following the sensor line LC in order to allow acquisition of side and bottom views.

In conclusion, the different variant embodiments of the launching means 30 combined with the different embodiments of the optical device 38 make it possible to adapt the device 10 according to the invention to the visual monitoring of a large number of products at high operating rates.

Of course, the invention also encompasses the variant embodiments of the launching means 30 in which the guide means 42 and the suction means 40 are suitable for launching the products P in a direction extending from the horizontal to the downward vertical.

1. Visual monitoring device (10) for products (P), comprising at least one conveyor (14) with at least one belt (16) transporting the products (P) in one direction (S) toward the visual monitoring means (18), and means for launching (30) products (P) through said visual monitoring means (18) that are located at the end (22) of said conveyor (14) following the direction (S), said visual monitoring means (18) comprising an image acquisition device (36) and an optical device (38), said visual monitoring device (10) being characterized in that the acquisition device (36) is a single camera, of sensor line (LC) and of axis (C1), oriented toward the trajectory (T) of the products (P) through the optical device (38), and in that the optical device (38) comprises at least one mirror (M2) located behind the trajectory (T) of the products (P), launched relative to the view point of the camera (36), a double periscope (104) inserted between the camera (36) and the trajectory (T) of the products (P), and at least two sets (M3A) and (M4A) of mirrors mounted symmetrically on either side of the axis (C1).

2. Device (10) for visual monitoring of products (P) according to claim 1, wherein the plane (T1), defined by the sensor line (LC) of the linear camera (36) and by its axis (C1), is secant to the direction (P1) of the trajectory (T) of the products in the optical device (38).

3. Device (10) for visual monitoring of products (P) according to claim 2, wherein the device (38) comprises one set of two mirrors (M2D) and (M2G) that are located behind the trajectory (T) of the products (P) relative to the view point of the camera (36) and are arranged symmetrically on either side of the axis (C1) of the camera, said mirrors (M2D) and (M2G) being oriented toward the trajectory (T) of the products (P) and both perpendicular to the plane (T1).

4. Device (10) for visual monitoring of products (P) according to claim 3, wherein the two mirrors (M2D) and (M2G) are tilted between ten degrees and twenty degrees relative to the sensor line (LC).

5. Device (10) for visual monitoring of products (P) according to claim 2, wherein the double periscope (104) comprises two sets (M1A) and (M1B) of two mirrors (M1A1, M1A2) and (M1B1, M1B2) in a V that is inverted by a quarter turn relative to the axis (C1) of the camera, said mirrors (M1A1, M1A2) and (M1B1, M1B2) of each set (M1A) and (M1B) being perpendicular relative to one another as well as relative to the plane (T1), and the mirror (M1A2) being oriented toward the trajectory (T) of the products (P).

6. Device (10) for visual monitoring of products (P) according to claim 5, wherein the set (M1A) of mirrors (M1A1, M1A2) is located on the axis (C1) between the camera (36) and the trajectory of the products (P), and wherein the second set (M1B) of mirrors (M1B1, M1B2) is located at a distance (DV1) from the first set (M1A) of mirrors (M1A1, M1A2).

7. Device (10) for visual monitoring of products (P) according to claim 2, wherein the device (38) comprises at least two sets (M3A) and (M4A) of mirrors, each set (M3A, M4A) respectively comprising one fixed mirror (M3AF, M4AF) that is oriented toward the trajectory (T) of the products (P) and one adjustable mirror (M3AR, M4AR) that is tilted, said mirrors (M3AF, M4AF, M3AR, M4AR) being perpendicular to the plane (T1).

8. Device (10) for visual monitoring of products (P) according to claim 7, wherein said sets (M3A) and (M4A) are mounted symmetrically on either side of the axis (C1), and wherein the fixed mirrors (M3AF, M4AF) are oriented at 70 degrees relative to the sensor line (LC) and toward the trajectory of the products (P), the adjustable mirrors (M3AR, M4AR) being positioned under said fixed mirrors and being inclined roughly 14 degrees relative to the sensor line (LC).

9. Device (10) for visual monitoring of products (P) according to claim 2, wherein the optical device (38) comprises two supplementary sets (M5A) and (M6A) that are arranged symmetrically in rotation around the axis (C1) of the camera and that respectively comprise one fixed mirror (M5AF, M6AF) and one adjustable mirror (M5AR, M6AR) that is tilted, and wherein the fixed mirrors (M5AF, M6AF) are oriented toward the trajectory (T) of the products (P) and arranged on an axis (F1) that is perpendicular to the axis (C1) of the camera and tilted at an angle (K1) relative to the plane (T1), the adjustable mirrors (M5AR, M6AR) being aligned to the sensor line (LC) of the camera.

10. Device (10) for visual monitoring of products (P) according to claim 9, wherein the angle of inclination (K1) of the axis (F1) relative to the plane (T1) is fixed to be equal to 30 degrees.

11. Device (10) for visual monitoring of products (P) according to claim 1, wherein the axis (C1) of the linear camera (36) is perpendicular to the direction (P1) of the launched products.

12. Device (10) for visual monitoring of products (P) according to claim 1, wherein the direction of passage (P1) of the trajectory (T) of the launched products (P) is a downward vertical.

13. Device (10) for visual monitoring of products (P) according to claim 1, wherein the plane (T1) is perpendicular to the direction (P1) of the trajectory (T) of the products in the optical device (38).

14. Device (10) for visual monitoring of products (P) according to claim 3, wherein the double periscope (104) comprises two sets (M1A) and (M1B) of two mirrors (M1A1, M1A2) and (M1B1, M1B2) in a V that is inverted by a quarter turn relative to the axis (C1) of the camera, said mirrors (M1A1, M1A2) and (M1B1, M1B2) of each set (M1A) and (M1B) being perpendicular relative to one another as well as relative to the plane (T1), and the mirror (M1A2) being oriented toward the trajectory (T) of the products (P).

15. Device (10) for visual monitoring of products (P) according to claim 4, wherein the double periscope (104) comprises two sets (M1A) and (M1B) of two mirrors (M1A1, M1A2) and (M1B1, M1B2) in a V that is inverted by a quarter turn relative to the axis (C1) of the camera, said mirrors (M1A1, M1A2) and (M1B1, M1B2) of each set (M1A) and (M1B) being perpendicular relative to one another as well as relative to the plane (T1), and the mirror (M1A2) being oriented toward the trajectory (T) of the products (P).
